(19) United States
(12) Patent Application Publication
(10) Pub. No.: US 2020/0368687 A1
(43) Pub. Date: Nov. 26, 2020

(54) PHOTOCHEMICAL REACTOR FOR ISOTOPE SEPARATION

(71) Applicant: America Air Liquide, Inc., Fremont, CA (US)

(72) Inventors: Alex AUGUSTINE, Wilmington, DE (US); Pascal Tessier, Hockessin, DE (US); Janna Register, College Station, TX (US)

(21) Appl. No.: 16/419,164

(22) Filed: May 22, 2019

(51) Int. Cl. B01D 59/34; B01D 59/30; B01D 59/32

(52) U.S. Cl. CPC B01D 59/34; B01D 59/32; B01D 59/30

(57) ABSTRACT

An isotope separation method, including introducing a first reactant stream (109), containing a natural abundance of at least one desired isotopologue molecule, a second reactant stream (110), and a recycle stream (112) into a photochemical reactor (101), thus producing a raw product stream (115), introducing the raw product stream (115) into a separation device (116), thus producing at least a product stream (117), a gas filter stream (113), and the recycle stream (112), and introducing at least a portion of the gas filter stream (113) into an unconventional (gas) filter (103), wherein the product stream (117) includes the at least one desired isotopologue molecule.

### BACKGROUND

Several of the rare isotopes of light elements have exceedingly high monetary value in the chemical, nuclear, and medical fields. These elements including, but not limited to, ¹³C, ¹⁴C, ¹⁵N, ¹⁷O, and ¹⁸O are generally separated by the conventional processes of chemical exchange or distillation. For example, ¹⁵N and ¹⁴N have been separated by chemical exchange of NH₃ in a mobile phase with NH₄+ in the solid phase of a cation exchange resin. In this case, ¹⁵N is equilibrium shifted to the solid phase, by a factor of approximately 1.03, such that ¹⁵NH₃ will elute slower from an adsorption column. Alternately, the isotopes ¹⁵N and ¹⁴N can be separated by cryogenic distillation of naturally occurring N₂. The rarer ¹⁵N₂ and ¹⁵N¹⁴N have slightly lower boiling points than the ¹⁴N₂ such that they can be enriched over a number of column stages, as illustrated for example in U.S. Pat. No. 7,828,939. The primary drawback of each of these methods is the exceedingly low separation factor, between 1.01 and 1.1. These methods are, therefore, typically applied in a multi-stage configuration with tens or hundreds of stages needed to achieve a 99+% pure product.

Another method of light isotope separation is laser excitation and reaction, as illustrated for example in U.S. Pat. No. 4,387,010. Certain molecules have absorption bands, associated with vibrational, electronic, or vibronic excitations, which differ sufficiently between isotopologues such that one can be selectively targeted by a certain wavelength of light. As used here, the term “isotopologues” is defined as molecules which differs only in isotopic composition. Generally, the higher valued, or most desirable, isotopologue is targeted for excitation. The higher value isotopologue is then reacted with another molecule such that the product is isotopically enriched. A conventional means of separation is then used to isolate the product molecule such as adsorption, cryogenic distillation, etc. Methods of this nature have achieved enrichment factors of up to 30 in a single stage. For instance, a method was disclosed which utilized a gas filter of natural abundance NO gas to refine the UV light from an ArF laser cell such that the transmitted portion was selective towards ¹⁵NO excitation (U.S. Pat. No. 4,387,010).

The primary excitation sources utilized in the literature examples are tunable lasers. A narrow wavelength laser is tuned to a target wavelength in which the greatest selectivity advantage is gained for the higher-valued isotope over the lower-valued one. The laser light is then passed through a device, such as a flow-cell, which contains the reaction mixture. The drawback of laser excitation sources is a high capital cost for the laser and a low power efficiency. Additionally, tunable lasers are highly precise devices, which must be operated within a very narrow window of control.

In some special cases, a spectral emission source can be used. If a spectral line is known that lies close to the appropriate target wavelength, it can be used. In one instance an iodine-emission tube, emitting 206.2 nm light, was used to preferentially excite the ¹³C and ¹⁸O isotopes of CO and react them to form C₃O₂, CO₂, and C(s) products. A Kr emission source, emitting 123.58 nm light, was also used to preferentially excite the ¹³C and ¹⁸O isotopes of CO and react them to yield C₃O₂ and CO₂ products (U.S. Pat. No. 4,374,010). This design has a huge advantage in that gas discharge emission tubes are low cost and reasonably efficient. Unfortunately, very few emission lines are known which lie close enough to isotopically selective target wavelengths to be generally applied.

In another instance, the spectral emission source gas is actually composed of the enriched isotope component such that it radiates the target wavelength. An example of this was patented by Bergheaud et al, for ¹⁹⁶Hg separation (U.S. Pat. No. 3,983,019). Unfortunately, this technique is significantly restricted to elemental or highly stable compounds for use as the emission source.

A number of reactors are described in the literature which utilize emission tubes to drive reactions. U.S. Pat. No. 7,695,675 describes the design of a photoreactor in which the reaction mixture is forced to flow in a helical path around the light source. This both increases the resonance time and maintains a high Reynolds number for the fluid. The patent KR101416067 describes a continuous flow reactor for water treatment in which a round mirror surface is used to reflect the transmitted light. This serves to increase the efficiency of the device. The patent US 2011/0237842A describes an arrangement where multiple emission tubes are arranged normal to the flow path. This ensures that the majority of the fluid stream receives a high intensity of light, even if the fluid is mostly opaque to the light. Some photoreactors, utilizing emission tubes, are modified with conventional filters such that the spectrum of light is modified in a preferential way for the reaction. For instance, EP 0803472A1 includes the use of quartz as an optical filter to preferentially transmit shorter wavelengths of light to a reactor. Finally, photoreactors have been designed in which Light Emitting Diodes (LEDs) are used as the light source (WO 2009/129993A1).

### SUMMARY

An isotope separation method, including introducing a first reactant stream (109), containing a natural abundance of at least one desired isotopologue molecule, a second reactant stream (110), and a recycle stream (112) into a photochemical reactor (101), thus producing a raw product stream (15), introducing the raw product stream (115) into a separation device (116), thus producing at least a product stream (117), a gas filter stream (113), and the recycle stream (112), and introducing at least a portion of the gas filter stream (113) into an unconventional (gas) filter (103), wherein the product stream (117) includes the at least one desired isotopologue molecule.

An isotope separation method, including introducing a first reactant stream (109), comprising a natural abundance of at least one desired isotopologue molecule, a second reactant stream (110), and a first recycle stream portion (112) into a first photochemical reactor (102), thus producing a raw product stream (115), introducing the raw product stream (115) into a first separation device (116), thus producing at least a crude product stream (117), a first gas filter stream (119), and a first recycle stream (112), introducing at least a portion of the crude product stream (123), and a second recycle stream portion (125) into a second photochemical reactor (127), thus producing an enhanced product stream (128), introducing the enhanced product stream (128) into a second separation device (129), thus producing at least a product stream (130), a second gas filter stream (133), and the second recycle stream (132), combining the first recycle steam (112) and the second recycle stream (132) and separating the combined stream into the first recycle stream portion (124) and the second recycle stream portion (125), wherein the product stream (130) comprises at least one desired isotopologue molecule.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic representation of the basic design of a single reaction chamber photochemical reactor, in accordance with one embodiment of the present invention.

FIG. 2 is a schematic representation of a photochemical reactor, in accordance with one embodiment of the present invention.

FIG. 3 is a schematic representation of a photochemical reactor, in accordance with one embodiment of the present invention.

FIG. 4 is a schematic representation of the overall process scheme of a single reaction chamber photochemical reactor, in accordance with one embodiment of the present invention.

FIG. 5 is a schematic representation of the overall process scheme of a double reaction chamber photochemical reactor, in accordance with one embodiment of the present invention.

FIG. 6 is a schematic representation of the light intensity for two different wavelengths absorbed by the species ^{x}A and ^{y}A, in accordance with one embodiment of the present invention.

FIG. 7 is schematic representation of hypothetical absorption coefficient profiles for species ^{x}A and ^{y}A, in accordance with one embodiment of the present invention.

FIG. 8 is schematic representation of an idealized example of the gas filter and reactor function, in accordance with one embodiment of the present invention.

FIG. 9 is a schematic representation of an axial flow configuration of the photochemical reactor, in accordance with one embodiment of the present invention.

FIG. 10 is a schematic representation of a radial flow configuration of a single reaction chamber photochemical reactor, in accordance with one embodiment of the present invention.

FIG. 11 is a schematic representation of a radial flow configuration of a double reaction chamber photochemical reactor, in accordance with one embodiment of the present invention,

FIG. 11a is a schematic representation of a radial flow configuration of a double reaction chamber photochemical reactor, indicating the first stage and second stage reaction chambers, in accordance with one embodiment of the present invention.

FIG. 12 is a schematic representation of multiple reaction chambers indicating one possible placement of catalyst inside the reaction chambers, in accordance with one embodiment of the present invention.

FIG. 13 is a schematic representation of an arrangement with two gas media filters, in accordance with one embodiment of the present invention.

FIG. 14 is a schematic representation of the inert insert, in accordance with one embodiment of the present invention.

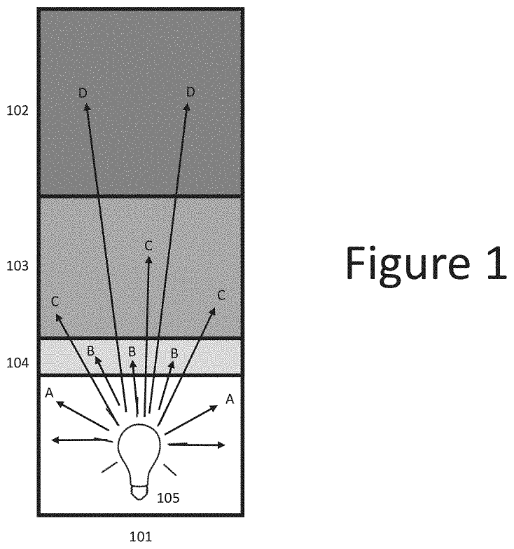

### DESCRIPTION OF PREFERRED EMBODIMENTS

### Element Numbers

A=unfiltered light from light source (105)
B=wavelengths blocked by conventional (solid) filter (104)
C=wavelengths blocked by unconventional (gas) filter (103)
D=desired wavelengths reaching reaction chamber (102)
101=photochemical reactor
102=reaction chamber (first stage reaction chamber)
103=optical gas filter (primary gas filter)
104=solid optical filter
105=light source
106=first transparent wall
107=second transparent wall
108=mirror back plate (for light source)
109=first reactant stream
110=second reactant stream
111=combined reactant stream (first combined reactant stream)
112=recycle stream (first recycle stream)
113=gas filter stream (entering gas filter) (high concentration/undesired isotopologues)
114=gas filter stream (exiting gas filter)
115=raw product stream
116=separation device (first separation device)
117=product stream (containing enriched concentration/desired isotopologues) (stage 1: partially enriched concentration/desired isotopologues)
118=first side product stream
119=first secondary reactant species stream
120=second sales or waste stream
121=third separation device (considered optional)
122=third sales or waste stream
123=Product stream (stage 2: enriched concentration/desired isotopologues)
124=first portion of recycle stream
125=second portion of recycle stream
126=second combined reactant stream
127=second stage reaction chamber
128=enhanced products mixture stream (stage 3: doubly enriched concentration/desired isotopologues)
129=second separation device
130=product stream (stage 4: doubly enriched concentration/desired isotopologues)
131=second side product stream
132=second recycle stream
133=second secondary reactant species stream
134=first glass capillary tube
135=second glass capillary tube
136=reflective layer
137=catalyst coating
138=first optical gas filter
139=inert insert

As schematically represented in the figures, a novel reactor 101 is disclosed for the separation of isotopes. Continuous spectrum light source 105 is passed through conventional filter, solid optical filter 104 to remove bulk undesirable wavelengths B. Light source 105 may be an incandescent lamp, or preferably, a light emitting diode (LED), or a gas discharge lamp. Light source 105 should be chosen for a peak power output near to the appropriate absorption band to drive the reaction. Light source 105 may include a mirrored back-plate 108 to increase the intensity of light directed towards the reactor. Conventional filter 104 may be chosen to target a range of light near to the appropriate absorption band and exclude light with energy of 40% less or 40% greater. For instance, if the target wavelength is in the ultraviolet region at 250 nm, conventional filter 104 would be chosen to exclude greater than 420 and less than 180 nm light; if the target light is in the infrared region at a wavenumber of 3,000 cm⁻¹, conventional filter 104 would be chosen to exclude greater than 1,800 and less than 4,200 cm⁻¹ light. Most crucially, light of higher energy should be excluded as it could result in undesirable side reactions or molecular dissociation.

The light is then passed through unconventional filter 103, herein referred to as a ‘gas filter’ or “optical gas filter”. Gas filter 103 consists of a chamber, with transparent walls, filled with the lower valued isotopologue. First transparent wall 106 defines the region proximate to, inside of, or outside of conventional (solid) filter 104. Second transparent wall 107 defines the inner boundary of unconventional (gas) filter 103, and defines the boundary of reaction chamber 102. With regard to the spectrum of light passing through the chamber D, the absorption spectrum of the low value isotopologue is eliminated and the transmittance spectrum, passed through, is appropriate for selective excitation of the higher valued isotopologue. Gas filter 103 may either be sealed or continuously purged to maintain its purity.

The light D transmitted by the gas filter 103 is passed to reaction chamber 102 where the mixture of isotopologues to be separated 109 plus a secondary reactant 110, forming at least part of combined reactant stream 111, are present. Filtered light selectively excites the higher valued isotopologue molecules present in first reactant stream 109, which then react with secondary reactant stream 110 to form raw product stream 115. Raw product stream 115 is isotopically enriched and can be separated by conventional means 116 from the reaction mixture.

Gas filter 103 function and design can be estimated starting from Beer's law equation 1.

$${A}_{λ i} = log ( \frac{{I}_{i , 0}}{{I}_{i}} ) = {α}_{i , j} {P}_{j} L \qquad Equation 1$$

where A_{λi} is the absorbance of light with wavelength λi, Iᵢ is the intensity of transmitted light with wavelength i, I_{i,0} is the intensity of light entering the gas filter, α_{i,j} is the absorption coefficient of the gas species j to the wavelength i, Pⱼ is the partial pressure of species j, and L is the length of the gas filter. Rearranging this equation to solve for the intensity of light transmitted gives the equation 2.

Iⱼ=I_{i,0}*10^{-α}^{ᵢ}^{P}^{ᵢ}^{L} Equation 2

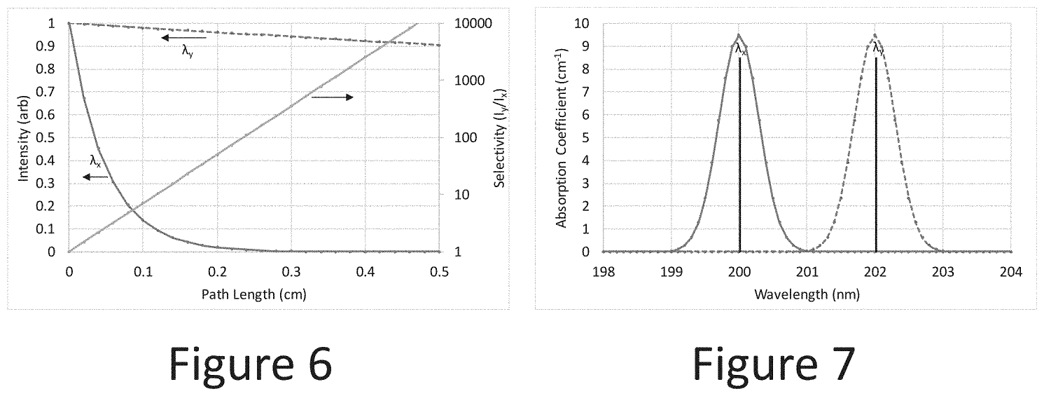

The absorption coefficients of each species can be measured experimentally in the region around the relevant wavelength. By equation 2, wavelengths of light which are absorbed by the primary species in the gas filter are absorbed exponentially faster than those absorbed by the scarcer species. FIG. 6 illustrates the light intensity for two different wavelengths absorbed by the species ^{x}A and ^{y}A with hypothetical absorption coefficient profiles given in FIG. 7. For the calculation, the mixture in the gas filter was assumed as 99 mol % ^{x}A and 1 mol % ^{y}A at standard temperature and pressure. In FIG. 6, the ratio of I_{y}/Iₓ is also plotted on the secondary axis as a simplified indicator of the selectivity of the transmitted spectrum.

As can be seen in FIG. 6, if the isotopologues ^{x}A and ^{y}A have two well resolved peaks in their absorption coefficient profiles, light of wavelength λ_{y} is primarily transmitted by the gas filter while light of wavelength λₓ is almost completely rejected. The light of wavelength λₓ is rejected exponentially faster than that of λ_{y} such that the ratio of I_{y} to Iₓ increases exponentially with the path length through the filter. This occurs due to the difference in concentrations between ^{x}A and ^{y}A only, as both species were assumed to have the same absorption coefficient. The length of an appropriate gas filter for a given reaction can be determined by this method, such that the selectivity, I_{y}/Iₓ, is greater than 100 or so, 0.25 cm for the gas pair shown in FIG. 6.

The calculation shown in FIGS. 6 and 7 is an idealized case. In real absorption spectra, a number of overlapping and partially overlapping peaks are present. If the same equations are applied to a set of peaks, some of which overlap and some of which are well resolved, the function will be the same; that is, the selectivity of the light will increase exponentially with path length. The light of wavelengths corresponding to poorly resolved peaks is rejected exponentially faster than the light corresponding to wavelengths of well resolved peaks corresponding to the low concentration isotopologue. Light corresponding to the poorly resolved peaks is fully absorbed by the high concentration isotopologue.

The transmitted light is then passed on to reaction chamber 102. Reaction chamber 102 consists of a continuous flow reactor, having at least one wall 107 which is transparent to the target wavelength of light. Reactant mixture 111 is introduced at one end of reactor 102 and product mixture 115 is withdrawn from the other end of reactor 102. Reactant mixture 111 includes an isotopic mixture, including the target isotopologue and optionally, a secondary species which has some reactivity with that molecule. The transmitted light D selectively interacts with the higher valued isotopologue, promoting it to an excited state. The excited isotopologue then reacts to form a product species at an increased rate. Since the light excitation was selective towards the higher valued isotopologue, reaction stream 111 will be enriched in that product isotopologue and the un-reacted starting material will be depleted.

The enrichment achievable by the device is a function of both the selectivity of the light passed by the gas filter and the resolution of the relevant absorption peaks in the molecules' absorption spectra. The concentration of each excited species [^{x}A] and [^{y}A*] can be estimated by derivation from a steady state mass balance for each species:

$$\begin{matrix}d [ {}_{}^{j}{A}{}_{}^{*} ] / dt = {\sum }_{i} \frac{{I}_{i} {α}_{i , j}}{{hv}_{i} {k}_{B} {T}_{STP}} ( [ {}_{}^{j}{A}{}_{0}^{} ] - {[}^{j} {A}^{*} ] ) - {r}_{d} {[}^{j} {A}^{*} ] \\ = 0\end{matrix} \qquad Equation 3$$

where [^{j}A*] is the concentration of excited state of species j, Iⱼ is the intensity of light at wavelength i, h is Plank's constant, vᵢ is the frequency of the light considered, k_{B} is the Boltzmann constant, T_{STP} is the standard temperature of 273 K, ^{j}A₀ is the concentration of ground state species j, and r_{d} is the decay rate for the excited state, accounting for all relaxation mechanisms. The summation sign in Equation 3 indicates the necessity to account for all wavelengths of light which can cause the excitation. For instance, a single electronic transition in a diatomic molecule at room temperature is typically composed of more than five measurable vibrational bands, separated by energies on the order of 2,000 cm⁻¹. Each vibrational band then contains a fine structure of over 20 measurable rotational bands, separated by energies on the order of 5 cm⁻¹. The Equation 3 can be simplified by the assumption that only weak pumping occurs ([^{j}A*]<<[^{j}A₀]), resulting in Equation 4.

$${[}^{j} {A}^{*} ] = {\sum }_{i} \frac{{I}_{i} {α}_{i , j}}{{hv}_{i} {k}_{b} {T}_{STP} {r}_{d}} [ {}_{}^{j}{A}{}_{0}^{} ] \qquad Equation 4$$

Equation 4 allows for an estimation of the concentration of excited species in the reaction mixture, which can then be used to estimate the overall reaction rate. The Equation 4 can also be used to estimate the light intensity required for a given device productivity. The enrichment factor for two species that is enabled by the device under ideal conditions is then given by equation 5.

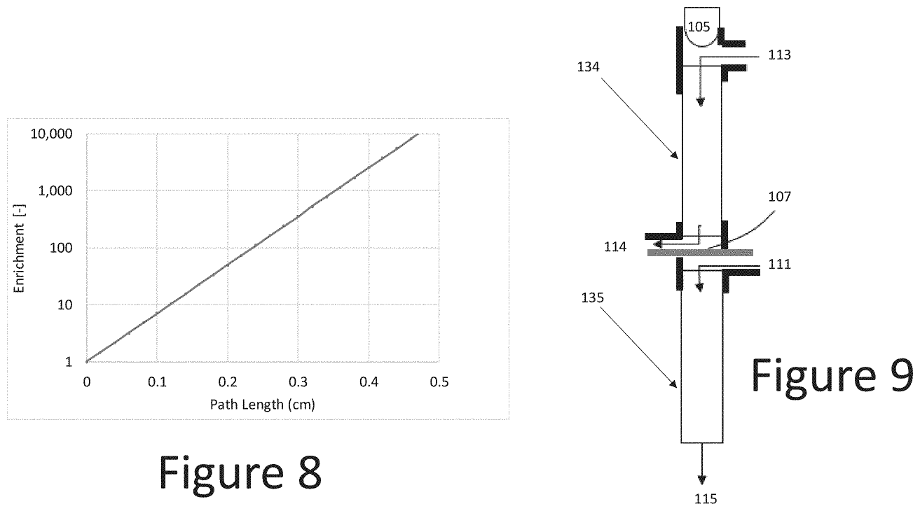

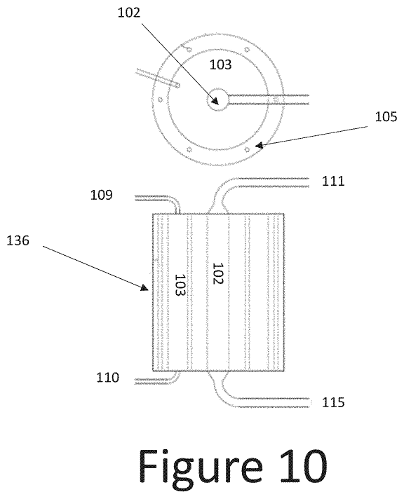

E=([^{y}A*]/[^{x}A*])/([^{y}A₀]/[^{x}A₀]) Equation 5

where ^{y}A is the lower concentration isotopologue and ^{x}A is the higher concentration one. If Equation 5 is solved by substitution with Equation 4, it can be referred to as the theoretical enrichment factor, which can readily be solved. For two isotopologues having well resolved absorption peaks, the theoretical enrichment enabled by the device as function of the gas filter length is shown in FIG. 8.

The theoretical enrichment factor enabled by the device increases exponentially with the selectivity of the light passed by the gas filter, which is a direct function of the gas filter length. The case illustrated by FIG. 8 is an idealized example of the gas filter and reactor function. As will be further detailed, a number of different secondary effects exist which result in lower effective enrichment values. Practically, enrichment factors in the range of 2 to 100 can be realistically expected. It should also be pointed out that longer gas filter length results in an overall exponential decay of the transmitted light intensity such that the efficiency of the device decreases.

A number of different reaction systems can be employed in the reactor such that it is necessary to better clarify the reaction system. The photo-excitation reaction is given by reaction I.

ⁿA+hv→^{y}A*+^{x}A Reaction I

where ⁿA is a chemical species containing a naturally occurring ratio of isotopologues, hv is a photon of light having the target wavelength, ^{y}A* is the excited state of the higher valued isotopologue, and ^{x}A represents one or more of the lower valued isotopologues. The excited state species then react to form products by one of several possible routes given by reactions II to V below.

^{y}A*+B→^{y}C Reaction II

^{y}A*→^{y}C+D Reaction III

^{y}A*+B→^{y}C+D Reaction IV

^{y}A*+B→^{y}C+D+^{y}E Reaction V

where ^{y}C is the product with an enriched ratio of the higher valued isotope, D is one or more side-products, possibly having an altered isotope ratio, B is a secondary reactant species, and ^{y}E is one or more additional side-products with an enriched ratio of the higher valued isotope.

The preferred embodiment of the invention is one in which the fewest number of reaction products are formed such that the product stream can be easily separated. As such, the simplest case is given by Reaction II, the excited state molecule A* reacts with a secondary reactant species B to form a single product C. Since ^{y}A* was preferentially enriched in the higher valued isotope, the product ^{y}C will also be enriched. The Reaction III describes a different scenario; the excited state molecule spontaneously splits into two or more products, one of which is enriched in the higher valued isotope. Finally, more complex reaction chemistries are given by reactions IV and V. In these two systems, multiple reactants react to form multiple products, with one or more products enriched in the high valued isotope.

The reactor effluent stream is different in each case, containing three or more molecular species, the unreacted, value-depleted ^{x}A, the unreacted B, the value-enriched ^{y}C, one or more side-products D, possibly having an altered isotopic ratios, and one or more side-products ^{y}E having altered isotopic ratios. A conventional separation process can be employed to separate the product mixture, with the particular choice of technology based on the chemical properties of each species. One or more of the isolated products will be isotopically enriched. The unreacted starting material will be isotopically depleted.

Another possible side-reaction which must be considered in the reactor is Reaction VI, which accounts for excited state transfer between isotopologue molecules.

^{y}A*+^{x}A→^{y}A+^{x}A* Reaction VI

Since the excitation energies of ^{y}A and ^{x}A are very nearly identical, the excited state energy can be readily transferred between the two species by a collision interaction. The Reaction VI provides a path by which the low valued isotopologue can react to form products such that it is termed ‘non-selective’. If the rate of Reaction VI is greater than the rate of product formation (for Reactions II, III, IV, or V), then the reactor products will have a low enrichment factor. The rate of Reaction VI can be decreased and the rate of product forming reactions increased by utilizing an excess of secondary reactant B such that A is dilute.

In order to maximize the use of light of the appropriate wavelength, a reactor with gas flow parallel to the direction of light can be envisioned such as shown in FIG. 9.

FIG. 9 schematically illustrates an arrangement in which the light 105 is admitted into one end 109 of a first glass capillary tube 133 containing the gas filter media 103. Gas filter media 103 is also supplied continuously flowing into first glass capillary 134. At the end of gas filter 103, the light passes through window 107 into a second glass capillary 135 used for reaction chamber 102. The reaction feed mixture 111 is introduced, continuously flowing, to one end of second glass capillary 135 and the product mixture withdrawn 115 from the other. In the FIG. 9 a co-current arrangement is shown but a counter-current arrangement may also be preferable.

The glass tube reactor arrangement can also be realized with extremely low diameter tubes, such as glass capillaries (hollow fibers), or so-called photonic crystals, which are optical fiber with an empty core surrounded by a plurality of empty channels which have the effect of forcing the light to propagate close to the core of the fiber. Such photonic crystals are manufactured for example by NKT Photonics or Photonics Bretagne.

Such a design as shown in FIG. 9 allows for more flexibility in the arrangement of reactors, connection to gas sources, and miniaturization. If the gas filter and reactor are designed around a selective set of absorption bands which have a weak adsorption coefficient, less than 0.5 cm⁻¹ for example, a long path length of 1 meter or greater may be necessary for the gas filter to achieve high selectivity. Additionally, if a low reaction operating pressure of less than 0.5 bara is needed to minimize non-selective interactions, a long path length will also be necessary. The glass capillary design allows for a long path length with minimal cost and system foot-print.

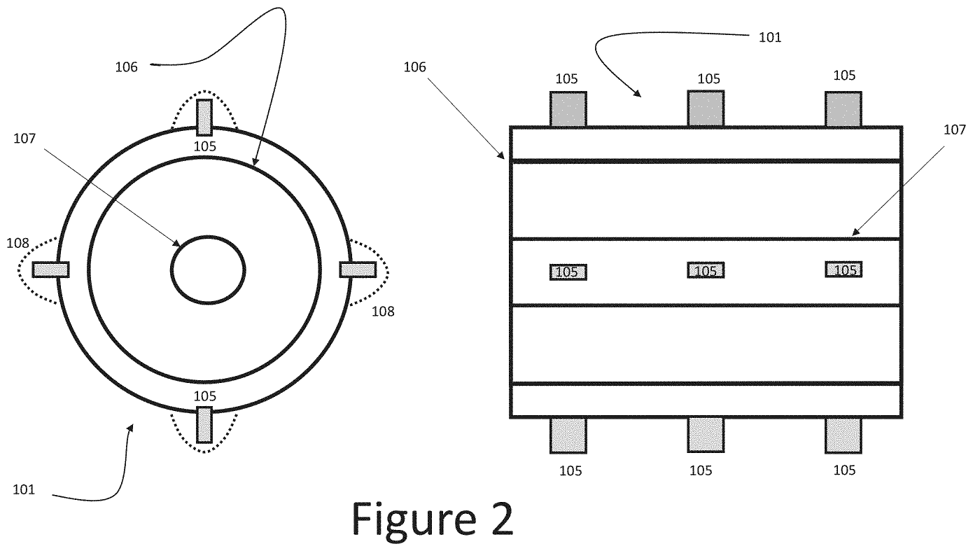

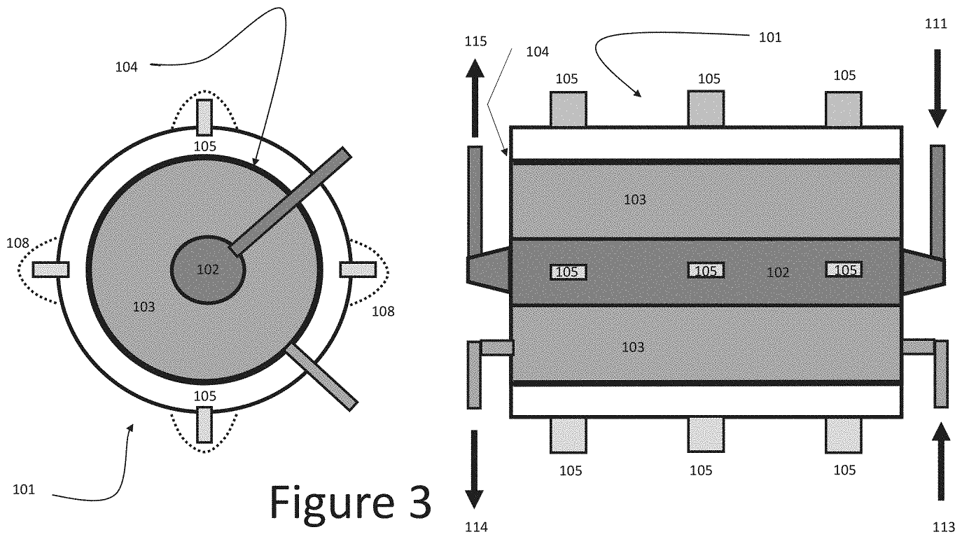

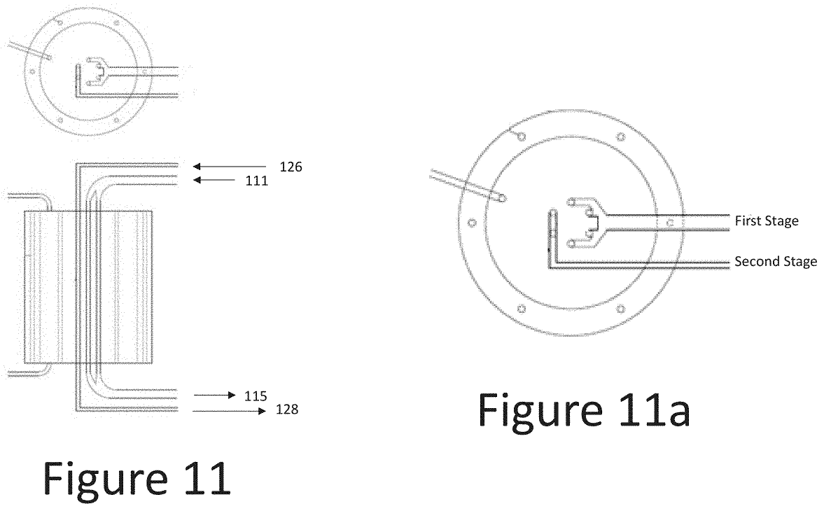

A preferable reactor geometry is given in FIGS. 2 and 3 for light source 105 that are point light sources such as LEDs and in FIG. 11 for light source 105 that are rod-shaped light sources such as emission tubes. Reaction chamber 102 is cylindrical, with multiple light emission sources 105 positioned radially around the perimeter of the device. Conventional optical filter 104 is also cylindrical in shape and also serves as one of the walls containing the gas filter media 103. Gas filter 103 is located inside of conventional filter 104 and includes a continuous purge stream entering at 113 and exhausting at 114. Reaction chamber 102 is also cylindrical in shape and is located inside of gas filter 103. Combined reactant stream 111 is fed into the reaction chamber 102 and exhausted as raw product stream 115. Reflective layer 136 may be positioned around the periphery of the device with a mirror on the inner surface such that any wide angled light from light source 105, or light transmitted through the reaction mixture, is reflected back towards the center of the device. Reflective layer 136 may also serve as a protective device, preventing dangerous light exposure of nearby personnel or equipment.

There are a few advantages of this radial reactor configuration. Since only a small fraction, perhaps less than 1%, of the emitted light is of the correct wavelength for selective excitation, a very high initial luminous output is needed. If a single source with sufficient power output is not available, multiple emission sources arrayed around the reactor can achieve the same effect. To allow for high throughput, higher space velocities of gas can be used. This is most efficiently contained in a small tube (or bundle of smaller tubes).

If gas filter 103 and reaction chamber 102 are designed around a selective set of absorption bands which have a strong adsorption coefficient, on the order of 5 cm⁻¹, and a pressure in excess of 1 bara can be used, only a very short path length of less than 1 cm is necessary for the gas filter to achieve high selectivity. If these operating parameters are chosen, then a cylindrical reactor geometry is preferable. On the other hand, if the relevant absorption coefficients are weak, or a low operating pressure is chosen, then a cylindrical arrangement such as shown in FIGS. 2, 3, and 11 is not preferable due to the large size requirement. In the case of a very short path length requirement, an alternate geometry can also be envisioned with many reactor tubes arrayed in a circle inside the gas filter. This design would increase the throughput of the reactor without increasing space velocity or dead-volume.

The specific method of using photochemical reactor 101 depends both on the specific type of reaction system being considered and on the optimal operating conditions: such as, but not limited to, pressure, temperature, and stoichiometry, for high isotopic selectivity.

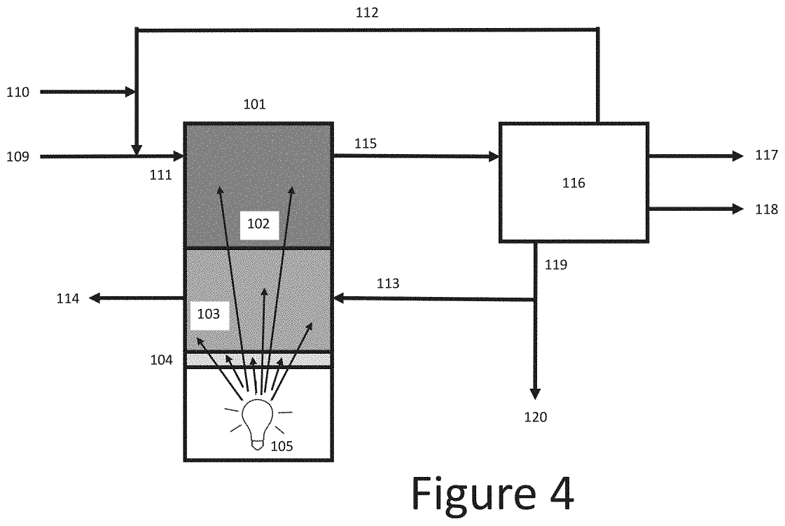

In general, a process scheme similar to that shown in FIG. 4 will be preferable. The process example takes into consideration a reaction system including reactions I and IV, as discussed above.

ⁿA+hv→^{y}A*+^{x}A Reaction I

^{y}A*+B→^{y}C+D Reaction IV

Stream 109, a mixture ⁿA, consisting of the molecule A with a natural abundance of isotopologues, is mixed with stream 110, consisting of component B, and sent to the reactor chamber 102. In reactor chamber 102 the higher valued isotopologue ^{y}A is selectively excited by light from the gas filter by reaction I, then reacts with component B by reaction IV. The reactor generates the ‘product mixture’, raw product stream 115 composed of ^{x}A, B, ^{y}C, and D.

Raw product stream 115 may be separated by a variety of conventional separation processes, including one or more of the following: cryogenic distillation, pressure or vacuum swing adsorption, solvent absorption, or membrane diffusion. The particular type of separation is chosen giving priority to the higher valued products, typically, but not necessarily, the rare isotope enriched ^{y}C species. It may be the case that the rare isotope has a much higher value than the natural abundance starting material ⁿA. In this case, the conventional separation should be designed for high recovery and/or high purity of the ^{y}C species. Alternately, it may be the case that either of the species, ^{x}A or B, have a moderate value and are present in significant excess with respect to the ^{y}C species. In this case, the conventional separation could be configured for high purity isolation of either species. Since the high valued isotopologue(s) are generally less than 1.5% in concentration versus the low valued isotopologue, a large volume of the low valued one will likely be present. To improve the economics of the process, stream 120, the isotopically depleted starting material ^{x}A, may be sold for conventional chemical use. Finally, if the species B is used in significant excess, recycle stream 112 may be returned to the reactor inlet. This may significantly reduce the required flowrate of stream 110, the make-up feed rate of B to the overall process.

Once raw product steam 115 has been separated, gas filter stream 113, comprising a portion of the low valued isotope stream, ^{x}A, may be recycled back to the reactor 101 to purge gas filter 103. Depending upon the light source and specific chemicals utilized, a side reaction is possible as given by reaction VII.

A*→D Reaction VII

where A is the excited state of either isotopologue and D is a degradation product with no isotopic enrichment. This non-selective reaction would quickly degrade the quality of the gas filter such that a continuous purge would be needed. The ^{x}A stream, which will be high volume, is ideally suited for this purpose. Separation device 116 may be configured to also remove first side product stream 118, consisting largely of degradation product D. Side-product(s), D, may have some value for conventional chemical use

Product stream 117, containing primarily the isotopically enriched product ^{y}C may be sold directly after purification. Alternatively, product stream 117 may be reacted by a variety of conventional processes to form other isotopically enriched species for sale (not shown).

In a preferred embodiment, the reactor 101 is operated at an elevated pressure, but not so high that collisional broadening reduces the selectivity of the device. The preferred pressure is on the order of 5 bara. At this pressure, the rotational fine structure of the absorbance spectrum is well resolved. Two different isotopologues necessarily have different rotational constants such that the spacing between rotational bands will result in high selectivity by the gas filter. At pressures exceeding 5 bara, collisional broadening results in overlap of the tails of each absorption peak, with a shape characteristically known as the Voigt profile.

Conversely, there is no preferable temperature at which the reactor is expected to operate better. Ideally, a temperature should be selected for the highest rate of the product forming Reaction II, III, IV, or V, but without significantly increased rate of the non-selective excitation transfer reaction VI or the degradation reaction VII. This should be decided on a case-by-case basis.

Accounting for some overlap in the absorbance spectra and the occurrence of the non-selective Reaction VI, an enrichment factor of between 2 and 30 is expected for the photochemical reactor. If the natural abundance of ^{y}A and ^{x}A are 0.4% and 99.6%, respectively, the product mix will contain an isotope composition of 0.8% to 12% of ^{y}C. It may be the case that the isotopically enriched product is sold directly. It is more likely the case that a higher level of enrichment is sought after such that it is preferable to reprocess the reaction product and send it to a second photochemical reactor stage. A multi-stage arrangement is proposed where the second, third, etc. stage reactor tubes receive light from the same source and through the same gas filter. An alternate reactor geometry is shown with regard to the radial design in FIG. 11.

In the FIG. 11, a radial reactor design is shown in which light sources 105 are arrayed around the perimeter of gas filter 103. Two sets of reaction tubes (102, 127) then pass through the center of gas filter 103, representing two different stages of a multi-stage device. In this non-limiting example, the first stage (102) is shown to include four tubes and the second stage (127) is shown to contain two. This is representative of the significantly smaller volumetric flow processed by the second stage. The primary advantage of the multi-stage design is that the reactor only requires one set of light sources 105 and one gas filter 103.

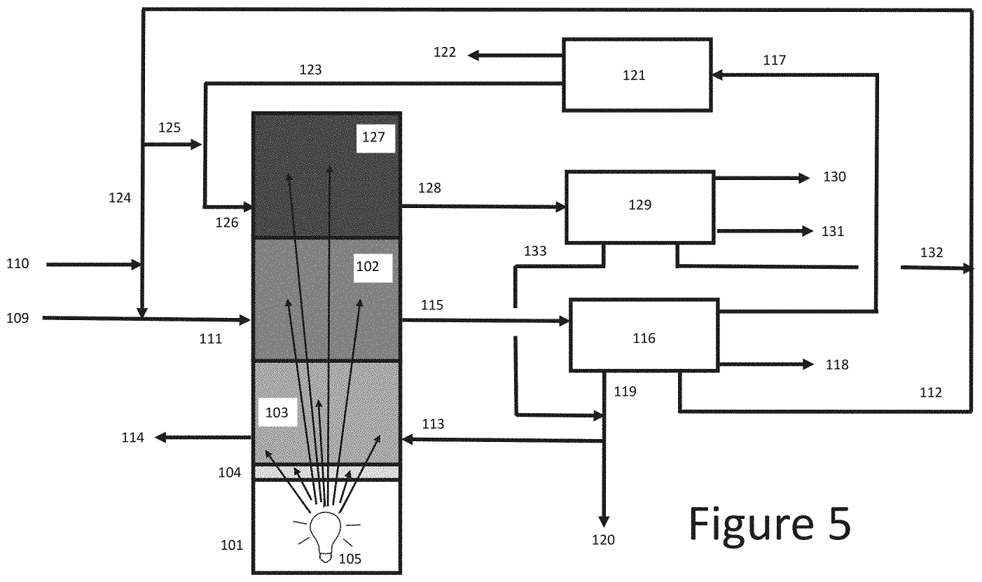

Turning to FIG. 5, additional advantages are apparent. The reaction system including reactions I and IV (discussed above) are used as an example, occurring in first stage reaction chamber 102. A modified reaction system is employed, having a different isotopic ratio, reaction I-2 and IV-2. These reactions take place in second stage reaction chamber 127.

^{y}A+hv→^{2y}A*+A Reaction I-2

^{2y}A*+B→^{2y}C+D Reaction IV-2

In this multi-stage process, first stage reaction chamber 102 and first separation device 116 operate in the same way as that described above. In FIG. 5, however, stream 117, containing the rare isotope enriched ^{y}C species is further processed by a conventional reactor to chemically convert it to an isotopically enriched species, ^{y}A. Stream 117 is optionally sent to a third separation device which may produce third sales or waste stream 122, and product stream 123. First portion 124 of combined recycle streams 112 and 132 is then combined with first reactant stream 109 and second reactant stream 110, to form first combined reactant stream 111, which enters first stage reaction chamber 102. Second portion 125 of this combined recycle streams 112 and 132 is then combined with product stream 123, to form second combined reactant stream 126, which enters second stage reaction chamber 127.

Enhanced products mixture stream 128 is then sent to second separation device 129 which separates out product stream 130, including primarily the rare isotope enriched ^{y}C species, and side product stream including second degradation product D′. The use of a single gas filter simplifies the process piping and handling of the depleted ^{x}A stream.

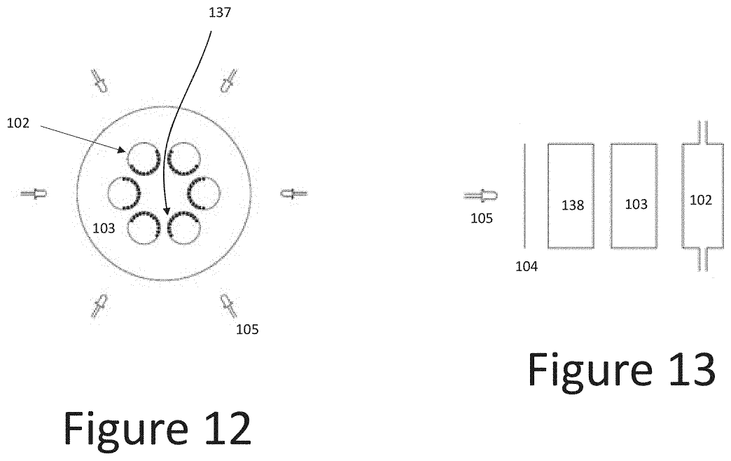

The design of the reactor geometry can be modified in a number of other ways to improve its operation. For instance, the reactor tube or tubes can assume a helical shape similar to that disclosed in US2003049809A (not shown). The advantage of this arrangement is a higher Reynolds number of the fluid and therefore better mixing at the same space velocity. Alternately, it may be that a catalyst is known which accelerates the product forming reaction II, III, IV, or V. If the catalyst is transparent to the target wavelength, it could be coated 137 on the interior surface of reaction chamber 102. Alternately, the catalyst could be coated on a coiled wire and inserted into the reactor tube (not shown). Alternately, a multi-tube reactor could be used with the catalyst coated preferentially on one side 137 of each tube as shown in the multi-tube reactor as indicated in FIG. 12. The catalyst is coated preferentially on the sides of each tube which face towards the center of the gas filter.

An additional variation of the reactor design considers the use of two gas cell in series as shown in FIG. 13. First gas filter 138 is used as a coarse filter to eliminate particular wavelengths which may cause degradation of the gas filter medium.

First gas filter 138 may consist of an elemental or very stable compound which has a broad absorption region. For instance, CO₂ has a broad, dissociative absorption band in the range of 140 to 165 nm. Water vapor has an absorption band in the range of 120 to 185 nm. Second gas filter 103 is then composed of the low valued isotopologue. Alternately, both the first gas filter 138 and second gas filter 103 may be swept with the same low valued isotopologue species. First filter 138 then acts as a sacrificial filter, from which a higher concentration of degradation products is produced. Primary gas filter 103 would then receive a lower intensity of light and produce fewer degradation products. The two filters could be operated at different pressures such that the first, at lower pressure, accumulates significant degradation impurities and is discarded afterwards. The second filter, at higher pressure, accumulates less impurities such that it can be sold to offset some operating expense.

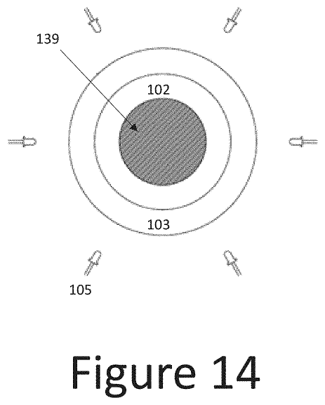

As indicated in FIG. 14, it may also be advantageous to place inert insert 139 into reaction chamber 102 to reduce dead volume. For the design case where the gas filter length is shorter than a few centimeters and the reactor path length is similarly short, sufficient light may not penetrate to the center of the reactor tube, resulting in a dead volume. In this case, inert insert 139 may be incorporated. Inert insert 139 may have a mirrored coating (not shown) such that light is reflected back through the reaction mixture. Inert insert 139 may have a catalyst coating (not shown) if appropriate. Inert insert 139 may have an absorptive coating to eliminate any light that has penetrated.

A cooling system (not shown) may be required to regulate the device temperature. This may be different for various embodiments, depending on the intensity of the light sources, the heat transfer resistance of the various materials, and the overall geometry. A photoreactor with incorporated cooling and of similar geometry is disclosed in WO2016026576. Tubing with heat transfer media could be incorporated in the center of the reactor with a similar geometry as shown in FIG. 2.

The operating methods for the photochemical reactor and process will be specific for each particular reaction system and are expected to conform to conventional chemical engineering design standards. Some operational aspects that are expected to be unique to the photochemical reactor are described herein.

Regarding the operation of the photochemical reactor process, isotopically depleted material ^{x}A may not be readily available in quantities sufficient to charge the gas filter for the initial start-up. In this case, the material A of natural isotopic abundance can be used until the separated products of the reactor effluent stream are available. Until the depleted ^{x}A is available, the gas filter will be less efficient at transmitting the target wavelength such that the reactor should be operated at a lower throughput.

Once the reactor is sized and built to a fixed dimension, the strongest lever by which the gas filter operation can be altered is the pressure. By increasing the gas filter pressure, the selectivity of the filter can be increased at the expense of the device productivity. The reaction selectivity can be easily monitored with conventional gas chromatography coupled with a mass spectrometer.

If the non-selective excited state transfer Reaction VI is known to be problematic, its rate can be decreased and the rate of product forming reactions increased by utilizing an excess of secondary reactant B such that A is dilute. Increasing the excess quantity of reactant B will lower the effective throughput of the device. The level of excess reactant B can be varied such that an optimal balance of high enrichment factor versus high device throughput is achieved.

Finally, the luminous intensity of the light source can also be altered to increase or decrease the reactor conversion at a given throughput. The light source should be operated at the greatest possible intensity for high throughput, but not so high that the photon flux approaches the decay rate of the target molecule, i.e. the assumption made in simplifying equation 3 to equation 4, that [^{j}A*]<<[^{j}A₀]. This limit can easily be determined on a case by case basis.

Sentence 1. A photochemical reactor comprising:
at least one light source (105),
at least one solid optical filter (104),
an optical gas filter (103), and
at least one reaction chamber (102).

Sentence 2. The reactor of sentence 1, wherein the at least one reaction chamber (102) is configured to react at least a first component (109) and a second component (110), wherein the first component (109) comprises a preferred isotopologue of a first compound.

Sentence 3. The reactor of sentence 1, wherein the light source (105) is selected from the group consisting of an incandescent lamp, a light emitting diode, or a gas discharge lamp.

Sentence 4. The reactor of sentence 1, wherein the solid optical filter (104) excludes light with energy either 40% greater than or 40% less than a predetermined adsorption band.

Sentence 5. The reactor of sentence 1, wherein the solid optical filter (104) consists of quartz, Pyrex, Vycor, or sodium chloride.

Sentence 6. The reactor of sentence 1, wherein the optical gas filter (103) comprises a gas media comprising an unwanted isotopologue of the first compound.

Sentence 7. The reactor of sentence 6, wherein the photochemical reactor is configured such that light emanating from the light source (105) first passes through the solid optical filter (104), then through the optical gas filter (103), resulting in light having a target wavelength bandwidth.

Sentence 8. The reactor of sentence 7, wherein the reaction chamber (102) comprises a curved surface at least a portion of which is essentially transparent to the target wavelength bandwidth.

Sentence 9. The reactor of sentence 7, wherein:
the reaction chamber (102) comprises a first cylindrical vessel,
the optical gas filter (103) is at least partially contained within a second cylindrical vessel, and solid optical filter (104), the optical gas filter (103), and the reaction chamber (102) in an axial direction.

Sentence 10. The reactor of sentence 7, comprising multiple light sources, wherein:
the reaction chamber (102) comprises a first cylindrical vessel,
the optical gas filter (103) is at least partially contained within a second cylindrical vessel which is external to and concentric with the first cylindrical vessel,
the solid optical filter (104) is arranged in a third cylinder which is external to and concentric with the second cylindrical vessel,
multiple light sources (105) are arranged in a fourth cylinder which is external to and concentric with the third cylinder, and
the light passes though the solid optical filter (104), the optical gas filter (103), and the reaction chamber (102) in the radial direction.

Sentence 11. The reactor of sentence 1, wherein the reaction chamber (102) comprises a continuous flow reactor.

Sentence 12. The reactor of sentence 1, wherein the reaction chamber (102) comprises an interior surface that is at least partially covered with a catalyst (137),

Sentence 13. The reactor of sentence 1, wherein the reaction chamber (102) comprises an interior volume, wherein a coiled wire coated with catalyst (137) is inserted into the interior volume.

1. An isotope separation method, comprising:
a) introducing a first reactant stream (109), comprising a natural abundance of at least one desired isotopologue molecule, a second reactant stream (110), and a recycle stream (112) into a photochemical reactor (101), thereby producing a raw product stream (115),
b) introducing the raw product stream (115) into a separation device (116), thereby producing at least a product stream (117), a gas filter stream (113), and the recycle stream (112), and
c) introducing at least a portion of the gas filter stream (113) into an unconventional (gas) filter (103),
wherein the product stream (117) comprises the at least one desired isotopologue molecule,
wherein the photochemical reactor (101) comprises:
at least one continuous spectrum point light source (105),
at least one solid optical filter (104),
the optical gas filter (103),
the least one reaction chamber (102).

2. (canceled)

3. The method of claim 1, wherein the photochemical reactor (101) is configured such that light emanating from the continuous spectrum point light source (105) first passes through the solid optical filter (104), then through the optical gas filter (103), resulting in light having a target wavelength bandwidth that selectively excites the desired isotopologue molecules in the first reactant stream (109), which then react with the second reactant stream (110), and the recycle stream (112).

4. The method of claim 1, wherein the separation device (116) is selected from the group consisting of distillation, cryogenic distillation, adsorption, absorption, membrane diffusion, extraction, or fractional condensation, or any combination thereof.

5. An isotope separation method, comprising:
a) introducing a first reactant stream (109), comprising a natural abundance of at least one desired isotopologue molecule, a second reactant stream (110), and a first recycle stream portion (112) into a first photochemical reactor (102), thereby producing a raw product stream (115),
b) introducing the raw product stream (115) into a first separation device (116), thereby producing at least a crude product stream (117), a first gas filter stream (119), and a first recycle stream (112),
c) introducing at least a portion of the crude product stream (123), and a second recycle stream portion (125) into a second photochemical reactor (127), thereby producing an enhanced product stream (128),
d) introducing the enhanced product stream (128) into a second separation device (129), thereby producing at least a product stream (130), a second gas filter stream (133), and the second recycle stream (132),
e) combining the first recycle steam (112) and the second recycle stream (132) and separating the combined stream into the first recycle stream portion (124) and the second recycle stream portion (125),
f) introducing at least a portion of the gas filter stream (113) into an unconventional (gas) filter (103),
wherein the product stream (130) comprises at least one desired isotopologue molecule,
wherein the first photochemical reactor (101) comprises:
at least one continuous spectrum point light source (105),
at least one solid optical filter (104),
the optical gas filter (103),
the least one reaction chamber (102),
wherein the second photochemical reactor (101) comprises:
at least one continuous spectrum point light source (105),
at least one solid optical filter (104),
the optical gas filter (103)
the least one reaction chamber (127).

6. The method of claim 5, further comprising the following step between steps d) and e),
d1) combining at least a portion of the first gas filter stream (119) and the second gas filter stream (133) and introducing at least a portion of the combined stream (113) into an optical gas filter (103),

7.-8. (canceled)

9. The method of claim 5,
wherein the at least one light source (105), the at least one solid optical filter (104), and the optical gas filter (103) are common to both the first photochemical reactor and the second photochemical reactor.

10. The method of claim 9, wherein the at least one solid optical filter (104) excludes light with energy either 40% greater than or 40% less than a predetermined adsorption band.

11. The method of claim 9, wherein the at least two reaction chambers (102, 127) comprise an interior surface that is at least partially covered with a catalyst.

12. The method of claim 9, wherein the at least two reaction chambers (102, 127) comprise an interior volume, wherein a coiled wire coated with catalyst is inserted into the interior volume.

13. (canceled)

14. The method of claim 5, wherein first photochemical reactor and the second photochemical reactor are configured such that light emanating from the continuous spectrum point light source (105) first passes through the solid optical filter (104), then through the optical gas, resulting in light having a target wavelength bandwidth.

15. The method of claim 5, wherein the separation device (116) is selected from the group consisting of distillation, cryogenic distillation, adsorption, absorption, membrane diffusion, extraction, or fractional condensation, or any combination thereof.
